(19) United States
(12) Patent Application Publication
(10) Pub. No.: US 2026/0195194 A1
(43) Pub. Date: Jul. 9, 2026

(54) System and method for revising classification parameters based on predicted data

(71) Applicant: Bank of America Corporation, Charlotte, NC (US)

(72) Inventors: Andrew Stellman, Brooklyn, NY (US); Narayana Sanjay Kumar, Naperville, IL (US)

(21) Appl. No.: 19/012,185

(22) Filed: Jan. 7, 2025

(51) Int. Cl. G06F 9/50

(52) U.S. Cl. CPC G06F 9/5088; G06F 2209/509

(57) ABSTRACT

A system for revising classification parameters for offloading tasks from a data center is disclosed. The system distributes first tasks to internal computing devices within the data center. In response, the system determines a first feedback metric that indicates a resource utilization pattern of the internal computing devices executing the first tasks. The system distributes second tasks to external computing devices with respect to the data center. In response, the system determines a second feedback metric that indicates a resource utilization pattern of the external computing devices executing the second tasks. The system determines a future task distribution trend from the data center to the set of external computing devices. If the system detects a fluctuation in the future task distribution trend, the system adjusts at least one classification parameter and/or adjusts a configuration criteria for which classification algorithm is to be implemented for an upcoming task.

### TECHNICAL FIELD

The present disclosure relates generally to data centers, and more specifically to a system and method for revising classification parameters based on predicted data.

### BACKGROUND

A data center is a physical facility used by organizations to house their Information Technology (IT) operations and equipment, such as servers, storage systems, networking hardware, and other critical infrastructure. Several inefficiencies are associated with conventional data centers in relation to configuring computational resources to various tasks. Additional inefficiencies exist in relation to optimizing power consumption in a data center.

### SUMMARY

The disclosed system, described in the present disclosure, is particularly integrated into a practical applications of improving the performance of data centers in performing computational tasks by (1) determining candidate tasks for offloading from the data centers using multi-tier classification techniques, (2) analyzing data center energy usage patterns, offloaded task success rates and failure rates, thermal dissipation factors associated with cooling systems of the data centers to adjust the classification parameters for determining candidate tasks for offloading from the data centers, and (3) revising classification parameters in multi-tier classification algorithms for determining whether to offload each task from a data center based on patterns in energy usage, resource availability, and thermal load of the data center. These practical applications provide several technical advantages, including increasing processing, memory, and resource utilization of computing devices at the data centers and reducing task failures.

In general, the disclosed system provides technological improvements to conventional techniques implemented in data centers for implementing and executing computational tasks. In some examples, computational tasks may include processing resource-intensive computational operations or functions, including, but not limited to, data rendering, data streaming, and data simulation, among others, where the data may include text, code, video, audio, or any other data format. In conventional systems, data centers spend a lot of computational resources to perform tasks. In conventional systems, static or fixed parameters are implemented to distribute tasks within data centers. However, using static or fixed parameters is not adaptable to dynamic changes or fluctuations in processing resource availability, network bandwidth, thermal conditions, and energy consumption. As a result, in conventional systems, data centers experience performance bottlenecks, increased task failure rate, and reduced processing and energy utilization.

In addition, an overloaded data center that is burdened with excessive amount of tasks requires additional cooling and hence, additional energy to run the cooling systems that provide cooling to the data center. For example, when conditions within a data center change, such as an unexpected surge of incoming tasks or an increase in thermal load due to the increase in the incoming workload, conventional systems are unable to respond dynamically, which leads to reduction in success rate for executing the incoming tasks, bottleneck in the queue of the tasks to be executed, network congestion to provide the results of the task, network latencies in communicating the results of the tasks, among others. Further, when tasks fail due to computational, network, and/or memory resource constraints at a data center, conventional systems are not configured to identify candidate tasks to redistribute or offload to external computing devices.

The disclosed system is configured to provide a technical solution to these and other technical problems in the conventional systems for managing and controlling the operations of data centers. The technical advantages and improvements over the conventional techniques are described below in conjunction with certain embodiments of the disclosed system.

In some embodiments, the disclosed system dynamically determines candidate tasks for offloading from a data center to one or more external computing devices. In this process, the system uses a multi-tier classification algorithm whose parameters are adapted based on fluctuations and patterns in computational resource availability, memory resource availability, network bandwidth availability, processing resource utilization, memory resource utilization, network bandwidth resource utilization, energy consumption patterns, energy consumption, thermal profiles, etc. (collectively referred to herein as conditions of a data center). Therefore, the system is configured to respond to fluctuations in various conditions that may affect the performance of data center in performing tasks. The system may adapt certain classification parameters of a multi-tier classification algorithm based on historical, current, and/or predicted aspects that may affect the performance of the data center in performing the assigned tasks.

In some embodiments, the disclosed system may identify which tasks are candidates to be offloaded from the data center based on task metrics and available resources (including processing, memory, and network resources) of external computing devices. If the disclosed system determines that a task is a candidate for offloading, the disclosed system may identify one or more external computing devices that, in the aggregate, are configured to execute the task. In response, if more than one computing device is identified to run the task, the system may divide the task into respective sub-tasks and communicate each sub-task to a respective computing device that is determined to have the capability to execute the respective sub-task. The computing devices may perform the respective subtask and provide the results of their execution to the server. The server may aggregate the received results.

In some embodiments, the system is configured to predict future resource demands (such as future processing, memory, and network resource demands) and task distribution trends. For example, the system may analyze the historical workload, task distributions, energy usage patterns, and resource consumption as feedback to predict potential surges in workload, thermal load increase, and network bandwidth requirement. In response, the system may proactively adjust the task classification parameters and the configuration of the classification algorithm to be used for determining which task candidates are to be offloaded from the data center, which tasks are conditional candidates for offloading, and which tasks to remain to be executed by the data center. In this manner, the system reduces bottlenecks in task queue, increases task success rate, and increases utilization in processing, memory, and network resources. This, in turn, increases the stability and performance of the data center.

In some embodiments, the disclosed system may recover a failed task. For example, after the task is offloaded to certain computing device(s), the server may monitor the execution of the task. If a computing device no longer has the available resources to execute task (or sub-task), the server may identify a counterpart computing device that is has the available resources to execute task (or sub-task) and communicate task (or sub-task) or cause the task (or sub-task) to be communicated to the counterpart computing device. In this manner, the system reduces task failure rate.

Accordingly, the present disclosure provides technological improvements to managing and controlling operations of the data centers.

Determining Candidate Tasks for Offloading from a Data Center

In some embodiments, a system comprises a memory operably coupled with a processor. The memory is configured to store information regarding a first task, wherein the first task is associated with one or more internal computing devices within a data center. The processor is configured to determine a set of task metrics associated with the first task, wherein the set of task metrics indicates whether the first task is a candidate for offloading from the data center. The processor is further configured to determine a distribution index for the first task based, at least in part, upon the set of task metrics. The processor is further configured to classify, based, at least in part upon the determined distribution index, the first task into one of a plurality of class tiers. Each class tier represents a level of suitability of the first task for offloading from the data center. The plurality of class tiers comprises a first class tier that indicates that the first task is suitable for offloading from the data center, a second class tier that indicates that the first task is conditionally suitable for offloading from the data center based, at least in part, upon available computational resources at one or more external computing devices with respect to the data center, and a third class tier that indicates that the first task is not suitable for offloading from the data center. The processor is further configured to determine that the first task belongs to the first class tier. The processor is further configured to determine a set of task requirements, wherein the set of task requirements indicates an amount of computational resources required to execute the first task, in response to determining that the first task belongs to the first class tier. The processor is further configured to determine a set of task requirements, wherein the set of task requirements indicates an amount of computational resources required to execute the first task. The processor is further configured to determine two or more external computing devices that, in the aggregate, meet the set of task requirements, wherein the two or more external computing devices are external with respect to the data center. The processor is further configured to indicate a network route in a network data packet that contains the information regarding the first task, wherein indicating the network route in the network data packet comprises buffering the network data packet in a network buffer prior to transmission and designating a network address associated with each of the two or more external computing devices in one or more bit-fields in a destination header of the network data packet; wherein the network address comprises an Internet Protocol (IP) address or a Medium Access Control (MAC) address. The processor is further configured to transmit the network data packet to the determined two or more external computing devices according to the network route.

### Revising Classification Parameters in Multi-Tier Classification Algorithms Based on Predicted Data

In some embodiments, a system comprises a memory operably coupled with a processor. The memory is configured to store a plurality of classification algorithms, wherein each of the plurality of classification algorithms is pre-configured with a set of classification parameters. The processor is configured to execute one of the plurality of classification algorithms to determine whether a given task is a candidate for offloading from a data center. The processor is further configured to distribute one or more first tasks to a set of internal computing devices within the data center for execution. The processor is further configured to determine a first feedback metric associated with the set of internal computing devices within the data center, wherein the first feedback metric indicates a resource utilization pattern of the set of internal computing devices executing the one or more first tasks, in response to distributing the one or more first tasks to the set of internal computing devices within the data center. The processor is further configured to distribute one or more second tasks to a set of external computing devices, wherein the set of external computing devices are external with respect to the data center. The processor is further configured to determine a second feedback metric associated with the set of external computing devices, wherein the second feedback metric indicates a resource utilization pattern of the set of external computing devices executing the one or more second tasks, in response to distributing the one or more second tasks to the set of external computing devices. The processor is further configured to determine a future task distribution trend from the data center to the set of external computing devices based, at least in part, upon the first feedback metric and the second feedback metric. The processor is further configured to detect a fluctuation in the future task distribution trend. The processor is further configured, for a first classification algorithm from among the plurality of classification algorithms, to adjust at least one of the sets of classification parameters based, at least in part, upon the first feedback metric and the second feedback metric, in response to detecting the fluctuation in the future task distribution trend. The adjustment to the at least one of the sets of classification parameters causes an adjustment in classification of an upcoming task by the first classification algorithm according to the detected fluctuation in the future task distribution trend. The processor is further configured to adjust a configuration criteria for which classification algorithm to be implemented for the upcoming task based, at least in part, upon the first feedback metric and the second feedback metric, wherein the adjustment to the configuration criteria allows that a classification algorithm that accommodates the detected fluctuation in the future task distribution trend is implemented.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured for determining candidates for task offloading using multi-tier classification in data centers and revising classification parameters based on predicted data;

FIG. 2 illustrates an example operational flow of the system of FIG. 1;

FIG. 3 illustrates an example flow chart of a method of the system of FIG. 1 for determining candidates for task offloading using multi-tier classification in data centers; and

FIG. 4 illustrates an example flow chart of a method of the system of FIG. 1 for revising classification parameters based on predicted data.

### DETAILED DESCRIPTION

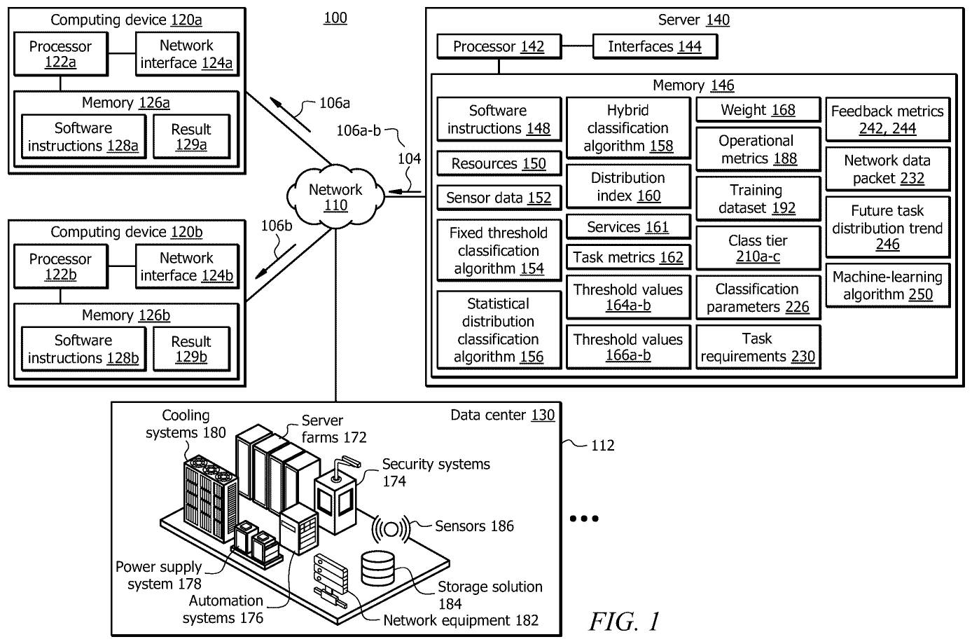

As described above, previous technologies fail to provide efficient and reliable solutions for offloading computational tasks from the data centers, detecting and mitigating failed tasks, and adapting to fluctuations in energy demand, resource availability, among other factors with respect to data centers. Embodiments of the present disclosure and its advantages may be understood by referring to FIGS. 1 through 4. FIGS. 1 through 4 are used to describe systems and methods for offloading computational tasks from the data centers, detecting and mitigating failed tasks, and adapting to fluctuations in energy demand, resource availability, among other factors with respect to data centers, according to some embodiments.

### System Overview

FIG. 1 illustrates an embodiment of a system 100 that is generally configured to improve the performance of data centers in performing computational tasks by determining candidate tasks for offloading from the data centers using multi-tier classification techniques. The system 100 is further configured to improve the performance of the data centers by analyzing data center energy usage patterns, offloaded task success rates and failure rates, thermal dissipation factors associated with cooling systems of the data centers, among other criteria, as feedback to adjust the classification parameters for determining candidate tasks for offloading from the data centers. The system 100 is further configured to recover failed tasks by redistributing a failed task to another computing device. In some embodiments, the system 100 comprises a server 140 communicatively coupled with one or more computing devices 120a-b (collectively referred to computing devices 120) and one or more data centers 130 via a network 110. The network 110 enables the communication among the components of the system 100. Each computing devices 120 may be a device to which a task 104 or a sub-task 106a-b of a task 104 is distributed or offloaded by the server 140. Each data center 130 may be a physical space or facility where computing devices in server farms are implemented to perform certain computational tasks 104. The server 140 may be a physical computing device configured to determine which tasks 104 are candidates to be offloaded from a data center 130 to one or more external computing devices 120 using multi-tier classification techniques, analyze data center energy usage patterns, offloaded task success rates and failure rates, thermal dissipation factors associated with cooling systems of the data centers, among other criteria, as feedback to adjust the classification parameters for determining candidate tasks for offloading from the data centers 130, and recover failed tasks by redistributing a failed task to another computing device. In other embodiments, system 100 may not have all of the components listed and/or may have other elements instead of, or in addition to, those listed above.

In general, the disclosed system 100 provides technological improvements to conventional techniques implemented in data centers for implementing and executing computational tasks 104. In some examples, computational tasks 104 may include processing resource-intensive computational operations or functions, including, but not limited to, data rendering, data streaming, and data simulation, among others, where the data may include text, code, video, audio, or any other data format. In conventional systems, data centers spend a lot of computational resources to perform tasks. In conventional systems, static or fixed parameters are implemented to distribute tasks within data centers. However, using static or fixed parameters is not adaptable to dynamic changes or fluctuations in processing resource availability, network bandwidth, thermal conditions, and energy consumption. As a result, in conventional systems, data centers experience performance bottlenecks, increased task failure rate, and reduced processing and energy utilization.

In addition, an overloaded data center that is burdened with excessive amount of tasks requires additional cooling and hence, additional energy to run the cooling systems that provide cooling to the data center. For example, when conditions within a data center change, such as an unexpected surge of incoming tasks or an increase in thermal load due to the increase in the incoming workload, conventional systems are unable to respond dynamically, which leads to reduction in success rate for executing the incoming tasks, bottleneck in the queue of the tasks to be executed, network congestion to provide the results of the task, network latencies in communicating the results of the tasks, among others. Further, when tasks fail due to computational, network, and/or memory resource constraints at a data center, conventional systems are not configured to identify candidate tasks to redistribute or offload to external computing devices.

The disclosed system 100 is configured to provide a technical solution to these and other technical problems in the conventional systems for managing and controlling the operations of data centers 130. The technical advantages and improvements over the conventional techniques are described below in conjunction with certain embodiments of the disclosed system.

In some embodiments, the disclosed system 100 dynamically determines candidate tasks 104 for offloading from a data center 130 to one or more external computing devices 120. In this process, the system 100 uses a multi-tier classification algorithm whose parameters are adapted based on fluctuations and patterns in computational resource availability, memory resource availability, network bandwidth availability, processing resource utilization, memory resource utilization, network bandwidth resource utilization, energy consumption patterns, energy consumption, thermal profiles, etc. (collectively referred to herein as conditions of a data center 130). Therefore, the system 100 is configured to respond to fluctuations in various conditions that may affect the performance of data center 130 in performing tasks 104. The system 100 may adapt certain classification parameters of a multi-tier classification algorithm based on historical, current, and/or predicted aspects that may affect the performance of data center 130 in performing the assigned tasks.

In some embodiments, the disclosed system 100 may identify which tasks 104 are candidates to be offloaded from the data center 130 based on task metrics and available resources (including processing, memory, and network resources) of external computing devices 120. If the disclosed system 100 determines that a task 104 is a candidate for offloading, the disclosed system 100 may identify one or more external computing devices 120 that, in the aggregate, are configured to execute the task 104. In response, if more than one computing device 120 is identified to run the task 104, the system 100 may divide the task 104 into respective sub-tasks 106a-b and communicate each sub-task 106a-b to a respective computing device 120 that is determined to have the capability to execute the respective sub-task 106a-b. The computing devices 120 may perform the respective subtask 106a-b and provide the results 129a-b of their execution to the server 140. The server 140 may aggregate the received results 129a-b.

In some embodiments, the system 100 is configured to predict future resource demands (such as future processing, memory, and network resource demands) and task distribution trends. For example, the system may analyze the historical workload, task distributions, energy usage patterns, and resource consumption as feedback to predict potential surges in workload, thermal load increase, and network bandwidth requirement. In response, the system 100 may proactively adjust the task classification parameters and the configuration of the classification algorithm to be used for determining which task candidates are to be offloaded from the data center 130, which tasks are conditional candidates for offloading, and which tasks to be remained to be executed by the data center 130. In this manner, the system 100 reduces bottlenecks in task queue, increases task success rate, and increases utilization in processing, memory, and network resources. This, in turn, increases the stability and performance of the data center 130.

In some embodiments, the disclosed system 100 may recover a failed task 104. For example, after the task 104 is offloaded to certain computing device(s) 120, the server 140 may monitor the execution of the task 104. If a computing device 120 no longer has the available resources to execute task 104 (or sub-task 106a-b), the server 140 may identify a counterpart computing device 120 that is has the available resources to execute task 104 (or sub-task 106a-b) and communicate task 104 (or sub-task 106a-b) or cause the task 104 (or sub-task 106a-b) to be communicated to the counterpart computing device 120. In this manner, the system 100 reduces task failure rate.

Accordingly, the system 100 provides technological improvements to managing and controlling operations of the data centers 130.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like to implement quantum communication channels. The network 110 may be configured to support any suitable type of communication protocol as would be appreciated by one of ordinary skill in the art.

### Example Computing Device

Each computing device 120 (e.g., each of computing devices 120a-b) may generally be any device that is configured to process data and interact with users. Examples of the computing device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by users.

Each computing device 120a-b may include a hardware processor, memory, and/or circuitry configured to perform any of the functions or actions of the computing device 120a-b described herein. For example, the computing device 120a-b includes a processor in signal communication with a network interface and a memory. The memory stores software instructions (e.g., code) that, when executed by the processor, cause the processor to perform one or more operations of the computing device 120 described herein.

The computing device 120a includes a processor 122a in signal communication with a network interface 124a and a memory 126a. The memory 126a stores software instructions 128a that when executed by the processor 122a cause the processor 122a to perform one or more operations of the computing device 120a described herein. The computing device 120a is configured to communicate with other devices and components of the system 100 via the network 110. The computing device 120a may be used to perform at least a portion of the task 104 (e.g., sub-task 106a) and provide the results 129a of the executed sub-task 106a to the server 140.

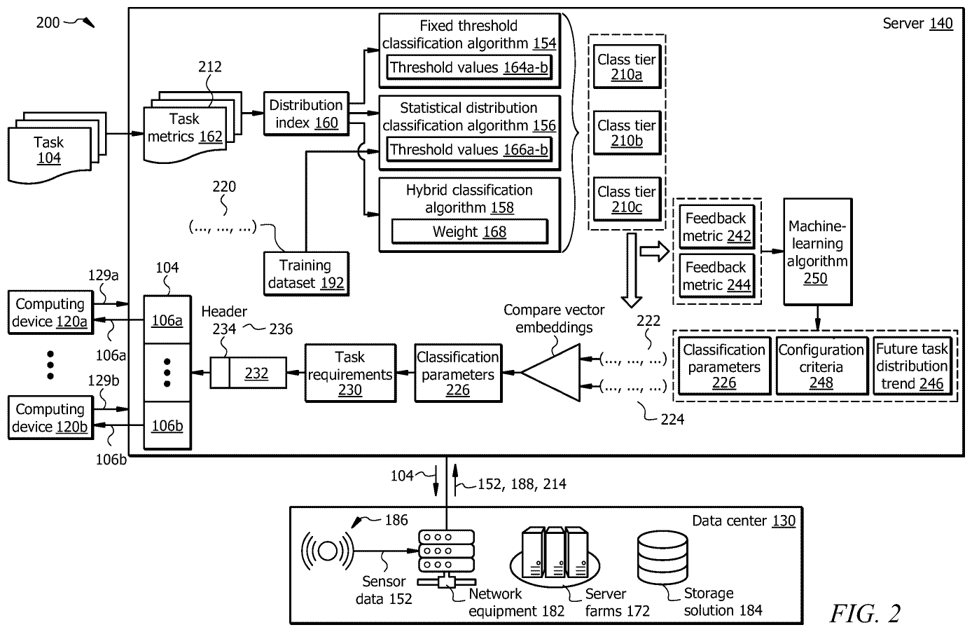

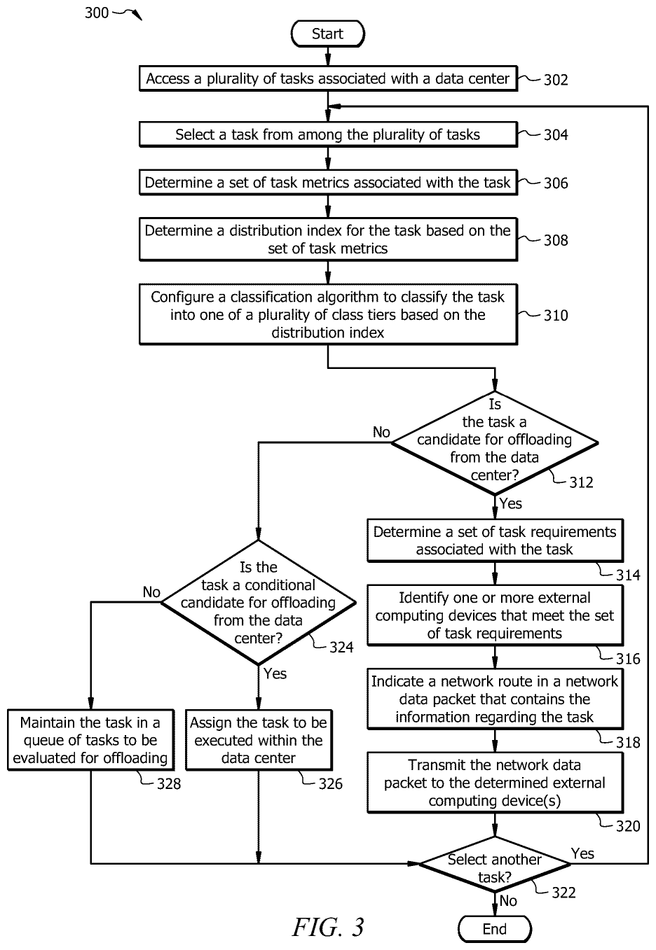

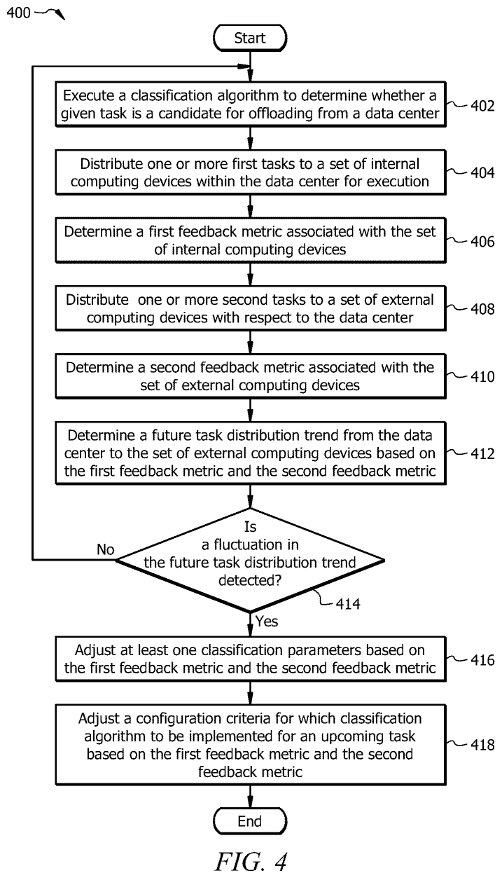

Processor 122a comprises one or more processors. The processor 122a is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 122a may be a programmable logic device, a microcontroller, a microprocessor, or any suitable number and combination of the preceding. The one or more processors are configured to process data and may be implemented in hardware or software. For example, the processor 122a may be 8-bit, 16-bit, 32-bit, 64-bit, or of any other suitable architecture. The processor 122a may include an arithmetic logic unit (ALU) for performing arithmetic and logic operations. The processor 122a may register the supply operands to the ALU and store the results of ALU operations. The processor 122a may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128a) to perform the operations of the computing device 120a described herein. In this way, processor 122a may be a special-purpose computer designed to implement the functions disclosed herein. In an embodiment, the processor 122a is implemented using logic units, FPGAs, ASICs, DSPs, or any other suitable hardware. The processor 122a is configured to operate as described in FIGS. 1-4. For example, the processor 122a may be configured to perform one or more operations of the operational flow 200 as described in FIG. 2, one or more operations of the method 300 as described in FIG. 3, and one or more operations of the method 400 as described in FIG. 4.

Network interface 124a is configured to enable wired and/or wireless communications. The network interface 124a may be configured to communicate data between the computing device 120a and other devices, systems, or domains. For example, the network interface 124a may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122a may be configured to send and receive data using the network interface 124a. The network interface 124a may be configured to use any suitable type of communication protocol.

The memory 126a may be a non-transitory computer-readable medium. The memory 126a may be volatile or non-volatile and may comprise read-only memory (ROM), random-access memory (RAM), ternary content-addressable memory (TCAM), dynamic random-access memory (DRAM), and/or static random-access memory (SRAM). The memory 126a may include one or more of a local database, a cloud database, a network-attached storage (NAS), etc. The memory 126a comprises one or more disks, tape drives, or solid-state drives, and may be used as an overflow data storage device, to store programs when such programs are selected for execution, and to store instructions and data that are read during program execution. The memory 126a may store any of the information described in FIGS. 1-4 along with any other data, instructions, logic, rules, or code operable to implement the function(s) described herein when executed by processor 122a. For example, the memory 126a may store software instructions 128a, results 129a, and/or any other data or instructions described herein. The software instructions 128a may comprise any suitable set of instructions, logic, rules, or code operable to execute the processor 122a and perform the functions described herein, such as some or all of those described in FIGS. 1-4. The results 129a may be the outcome of the execution of the sub-task 106a.

The computing device 120b is the same or substantially the same as the computing device 120a. For example, each component of the computing device 120b may be the perform the same or similar operations of the counterpart component of the computing device 120a as described above. The computing device 120b includes a processor 122b in signal communication with a network interface 124b and a memory 126b. The memory 126b stores software instructions 128b that when executed by the processor 122b cause the processor 122b to perform one or more operations of the computing device 120b described herein. For example, the processor 122b may be the same as or substantially similar to the processor 122a, the network interface 124b may be the same as or substantially similar to the network interface 124a, and the memory 126b may be the same as or substantially similar to the memory 126a. The computing device 120b may be used to perform at least a portion of the task 104 (e.g., sub-task 106b) and provide the results 129b of the executed sub-task 106b to the server 140.

### Example Data Center

The data center 130 may be one or more physical spaces or facilities where computing devices in server farms 172 are located and implemented, and are tasked to perform certain computational tasks 104. The data center 130 may store application information (e.g., service configurations) and data associated with one or more operations performed in the communication network. The data centers 130 may be a location where computing and networking equipment is used to collect, process, and store data, as well as to distribute and enable access to processing resources, memory resources, and/or power resources. In some embodiments, the server 140 may be located in one or more of the data centers 130. In some embodiments, the server 140 may be in signal communication with the data centers 130 via the network 110.

In some embodiments, the data center 130 may include one or more server farms 172, security systems 174, automation systems 176, power supply systems 178, cooling systems 180, network interfaces 182, storage solutions 184, and sensor circuits 186. These components are exemplary and the data center 130 is not limited to these components. In some embodiments, the data center 103 may include some of these components and/or other components. The components of the data center 130 may be communicatively coupled to one another via wired and/or wireless communication.

The data centers 130 may employ a combination of hardware sensor circuits 186 and service (e.g., software applications) to record one or more operational metrics 188 associated with the data centers 130. In some embodiments, the hardware sensor circuits 186 include, but are not limited to, climate sensor circuits, power sensor circuits that measure power consumption, humidity sensor circuits, differential pressure sensor circuits that monitor airflow by measuring pressure differences between different areas of a data center 130 or data center sub-systems, and vibration sensor circuits. The services may be configured to monitor and record operational metrics 188 may include performance monitoring (PM) tools that are configured to monitor, measure and/or determine several operational metrics 188 associated with the data center 130 such as central processing unit (CPU) response time, CPU usage, memory usage, error rate, application response time, availability of an application, throughput, network latency, disk input (I)/output (O) and the like. For example, a performance monitoring tool may determine the CPU response time based on the measured CPU utilization percentage.

In one or more embodiments, each of the data centers 130 (e.g., the data center 130 in the geographical location 112) may comprise one or more computing devices configured to communicate with other devices, such as the server, one or more of the sub-systems, databases, and the like in the system 100. Each of the data centers 130 may be configured to perform specific functions described herein and interact with the server 140 and/or any other data centers 130. Examples of computing devices in the data centers 130 comprise, but are not limited to, a laptop, a computer, a smartphone, a tablet, a smart device, an internet-of-things (IOT) device, a simulated reality device, an augmented reality device, or any other suitable type of device. The data centers 130 may comprise one or more interfaces and/or peripherals comprising I/O displays, voice microphones, or sensor circuits capturing gestures performed by a corresponding user.

The data centers 130 may comprise hardware configured to create, transmit, and/or receive information. The data centers 130 may be configured as a provider node or as worker nodes in the network 110. The data centers 130 may be configured to receive inputs from a user, process the inputs, and generate data information or command information in response. The data information may include informational messages, error messages, and/or documents or files generated using a graphical user interface (GUI). The informational messages and the error messages may be generated based on recorded values of one or more operational metrics 188 and may include the recorded values of the one or more operational metrics 188 and other information such as alerts and recommendations.

The data centers 130 may employ systems that generate and/or are used to generate performance indicators indicating performance of various hardware and/or software components associated with a given data center 130. Each performance indicator may include, but is not limited to, informational messages, error messages, recorded values of operational metrics 188, or a combination thereof. An informational message in a data center 130 may be a notification that provides details about a previous status and/or current status of a system and/or device within the given data center 130, indicating and/or referencing normal operations, non-critical events, and/or updates without any immediate action required. In some embodiments, an informational message is a message conveying non-urgent information about one or more conditions and/or functionality at the data center 130. An error message in a data center 130 may be a notification that alerts operators (e.g., users) to a problem and/or solvable event occurring within the data center infrastructure, such as a server malfunction, network connectivity loss, storage failure, and/or power supply issue, signaling that something is not functioning as expected and needs attention.

In one or more embodiments, the one or more interfaces may be any suitable hardware or software (e.g., executed by hardware) configured to facilitate any suitable type of communication in wireless or wired connections. These connections may comprise, but not be limited to, all or a portion of network connections coupled to additional data centers 130, the server 140, the Internet, an Intranet, a private network, a public network, a peer-to-peer network, the public switched telephone network, a cellular network, a LAN, a MAN, a WAN, and a satellite network. The interfaces may be configured to support any suitable type of communication protocol. In one or more embodiments, the one or more peripherals may comprise audio devices (e.g., speaker, microphones, and the like), input devices (e.g., keyboard, mouse, and the like), or any suitable electronic component that may provide a modifying or triggering input to the data centers 130. For example, the one or more peripherals may be speakers configured to release audio signals (e.g., voice signals or commands) during media playback operations. In another example, the one or more peripherals may be microphones configured to capture audio signals. In one or more embodiments, the one or more peripherals may be configured to operate continuously, at predetermined time periods or intervals, or on-demand.

The one or more processors may be communicatively coupled to and in signal communication with the one or more interfaces, the one or more peripherals, and the one or more memories. The one or more processors may be any electronic circuitry, including, but not limited to, state machines, one or more CPU chips, logic units, cores (e.g., a multi-core processor), FPGAs, ASICs, or DSPs. The one or more processors may be programmable logic devices, microcontrollers, microprocessors, or any suitable combination of the preceding. The one or more processors may be configured to process data and may be implemented in hardware or software executed by hardware. For example, the one or more processors may be 8-bit, 16-bit, 32-bit, 64-bit, or any other suitable architecture. The one or more processors may comprise an ALU to perform arithmetic and logic operations, processor registers that supply operands to the ALU, and store the results of ALU operations, and a control unit that fetches software instructions such as data center instructions from the memory and executes the instructions by directing the coordinated operations of the ALU, registers, and other components via a processing engine. The one or more processors may be configured to execute various instructions.

The memory may comprise multiple operation data and one or more local applications (e.g., server) associated with the server 140. The operation data may be data configured to enable one or more data processing operations such as those described in relation with the server 140. The operation data may be partially or completely different from those comprised in the storage solutions 184. The local applications may be one or more of the services described in relation with the server 140. In some embodiments, the local applications may be partially or completely different from those comprised in the storage solutions 184.

Referring as a non-limiting example to the data center 130 of FIG. 1, the data center 130 may include hardware and/or software, executed by hardware, that manages, controls, and/or monitors the resources 150 and/or data stored in the data center 130. Although not explicitly shown in FIG. 1, the data center 130 may include one or more processors, one or more memories, and one or more transceivers configured to generate one or more communication signals. In one or more embodiments, the data center 130a may include a device, a system, and/or a combination of systems and/or devices in a predetermined geographical location 112 in which the server 140 and/or the computing devices 120 are located. In some embodiments, radio waves, electromagnetic (EM) signaling, and/or communication operations from the data center 130 are monitored over time (e.g., by the server 140) in the network 110 to be evaluated in combination with the operational metrics 188, operational data 214, feedback metrics 244, sensor data 152, among others.

In one or more embodiments, operational metrics 188 associated with a given data center 130 may comprise measurable units that indicate performance of a data center equipment (or component therein) or a software application. The operational metrics 188 may be monitored and measured in a data center 130 including, but not limited to, ventilation levels associated with a data center equipment (e.g., server farms 172) or a component therein (e.g., CPU), power consumption of a data center equipment, humidity, airflow, vibrations, CPU response time, CPU usage, memory usage, error rate, application response time, availability of an application, throughput, network latency, and disk I/O. CPU response time is a measure of the time taken by a CPU to respond to a request. CPU usage is a percentage of processing power utilized by software applications running at one or more server farms 172 that may highlight potential performance bottlenecks. The memory usage is an amount of memory (e.g., random access memory (RAM)) consumed at the one or more server farms 172. The error rate may be a percentage of requests that result in error, signifying application stability and potential anomalies. The application response time may indicate a time taken by a software application to respond to a request indicating how quickly the application reacts to interactions. The availability of an application may be a percentage of time a software application is operational and accessible to users and systems. The throughput may be a number of requests that the server farms 172 or a software application can process per unit time (e.g., per second) indicating its capacity to manage traffic. The network latency may be a time that takes for data to travel between one or more elements in the data center equipment and/or data center sub-systems. The disk I/O may be a rate at which data is read and written to a storage device.

The one or more server farms 172 may be one or more server clusters and/or a collection of computer servers maintained and/or provisioned dynamically and/or periodically over time. The server farms 172 may comprise large numbers of servers comprising several (e.g., hundreds, thousands, and/or hundreds of thousands) computing systems and/or devices. The server farms 172 may comprise one or more servers configured to perform one or more specific operations in accordance with one or more specific services, i.e., tasks 104. The server farms 172 may be comprise one or more backup units configured to provide redundancies and/or support to one or more operations, i.e., tasks 104 in a given data center 130. The server farms 172 may comprise one or more core processing units that run various tasks 104 and sometimes store data. The server farms 172 may be deployed at a data center 130 to comprise several types of storage devices and systems such as traditional hard drives (HDDs), solid-state drives (SSDs), and specialized systems like Storage Area Networks (SANs) or Network-Attached Storage (NAS). The server farms 172 may comprise servers configured with and/or comprising networking equipment comprising switches and routers that facilitate internal communication between data center equipment (e.g., between servers) as well as external communication between the data center 130 and devices/systems external to the data center 130 (e.g., other data centers 130). As shown in the example of FIG. 1, a data center 130 may comprise at least one server farm 172 comprising multiple server racks that house several types of data center equipment. For example, a server rack may include servers, networking equipment (e.g., switches and/or routers), storage solutions, power distribution units (PDUs) that distribute electrical power to equipment within a server rack, cables that connect different devices within the rack and other part of the data center 130, patch panels used to organize and manage network cables, cable management system that assists in keeping cables organized and prevent clutter, or combinations thereof.

In one or more embodiments, tasks 104 and/or software applications that are hosted and/or run in the data center 130 (e.g., by servers in the server farms 172) may include, but are not limited to, operating systems, virtualization software, management and orchestration software, security systems 174, performance monitoring tools, backup and recovery software, database management systems (DBMS), or a combination thereof.

The one or more security systems 174 may be configured to protect one or more components of a data center 130 from unauthorized access, theft, and/or corruption. The one or more security systems 174 may comprise network security configured to use firewalls, intrusion detection systems, and other security measures to protect the network 110 that connects the data center 130. The one or more security systems 174 may comprise intrusion detections configured to use intrusion detection systems (IDS) to identify unauthorized access to the data center 130 and alert security personnel. The one or more security systems 174 may comprise one or more firewalls configured to use security systems to monitor and control incoming and outgoing network traffic. The one or more security systems 174 may be comprise data encryption configured to use data encryption to ensure information that is unreadable to unauthorized users. The one or more security systems 174 may comprise access controls configured to enable tasks 104 in one or more servers, allow access based on authorization commands, and use strong safety controls. The one or more security systems 174 may comprise data center security encompassing practices and preparation configured to keep a given data center 130 secure from threats, attacks, and unauthorized access.

The one or more automation systems 176 may be hardware and/or software executed by hardware configured to manage and/or execute routine data center operations like provisioning servers, monitoring performance, managing storage, network configuration, and disaster recovery without manual intervention, optimizing efficiency and reducing human error. The one or more automation systems 176 may comprise one or more routine workflows and processes of a data center 130 comprising scheduling, monitoring, maintenance, application delivery, and the like.

The one or more power supply systems 178 may be configured to receive, process, and/or distribute power in the data center 130. The one or more power supply systems 178 may comprise one or more uninterruptible power supplies (UPSs), one or more power distribution units (PDUs), and one or more remote power panels (RPPs). The UPSs may comprise battery backups to cover a time between a detection of utility issues and a generator starting. The PDUs may comprise individual equipment racks that are served by PDUs offering both metered and unmetered options. With metered PDUs, the data center 130 may obtain more analytics associated with power consumption. The RPPs may comprise connectors between the PDUs and the individual devices. The one or more power supply systems 178 may be configured to retrieve data from a power generator, an electrical grid, and/or an alternative power source prior to distribution in the data center 130. The one or more power supply systems 178 may be configured to provide electrical power to various data center equipment and components thereof in a data center 130 such as servers, networking equipment, storage solutions, and cooling solutions.

The one or more cooling systems 180 may be configured to regulate and/or control humidity and/or airflow within the data center 130, ensuring proper functioning of sensitive computer servers by maintaining a consistent cool environment and filtering out dust particles that could damage equipment. The one or more cooling systems 180 may comprise one or more solutions configured to prevent overheating of servers and other hardware within the data center 130. The one or more cooling systems 180 may comprise chillers and cooling towers configured to cool water that circulates through the data center 130, absorb heat from the air, and/or dissipate heat into the atmosphere, ensuring the water remains at an optimal warmth and/or cool level. The one or more cooling systems 180 may comprise one or more air distribution systems configured to ensure that cooled air is evenly distributed throughout the data center 130, maintaining uniform conditions across all server racks. The one or more cooling systems 180 may be configured to maintain optimal climate conditions for the data center equipment and may include air conditioning systems, liquid cooling systems, and/or other systems employing advanced cooling technologies to avoid and/or prevent overheating of data center equipment (e.g., servers).

The one or more network interfaces 182 may include networking hardware such as switches, routers, and network interface cards (NICs) that facilitate communication within the data center 130 and with external computing devices. These interfaces support various communication protocols and provide connectivity between the server farms 172, storage solutions 184, and other data center components. The network interfaces 182 may also connect the data center 130 to external networks, to enable the distribution of tasks 104 and retrieving the results 129.

The one or more storage solutions 184 may include various types of storage devices and systems used to store and manage data within the data center 130. In some examples, the storage solutions 184 may include hard disk drives (HDDs), solid-state drives (SSDs), storage area networks (SANs), and network-attached storage (NAS), and the like. The storage solutions 184 provide storage capacity for tasks 104, software applications, and system data. The storage solutions 184 may be connected to the server farms 172, network interfaces 182, and automation systems 176 for data access, retrieval, and backup operations via wired and/or wireless connections.

The one or more sensor circuits 186 may include hardware sensing elements and components that monitor various environmental and operational parameters within the data center 130. The sensor circuits 186 may be positioned at any suitable locations. The sensor circuits 186 may include thermal sensor circuits, humidity sensor circuits, power sensor circuits, airflow sensor circuits, and vibration sensor circuits. The sensor circuits 186 collect sensor data 152 (e.g., in real-time or near real-time within a threshold latency) on conditions such as thermal profiles, power usage, and environmental stability. The sensor data 152 may be analyzed by the server 140 to determine at least a portion of operational metrics 188 of the data center 130. In response, the server 140 may perform certain operations to improve the control and operations of the data center 130 as described herein.

The operational metrics 188 may include various measurable parameters that reflect the conditions, performance, and resource usage of the data center 130. In some examples, the operational metrics 188 may include processing resource utilization, which reflects the percentage of CPU usage across servers, memory usage, which indicates the amount of RAM consumed by active processes (e.g., tasks 104 being executed), and network bandwidth usage, which indicates the rate of data transfer within the data center network infrastructure. Additionally, the operational metrics 188 may include thermal conditions, which are derived from thermal sensor data readings within the data center 130, energy consumption which reflects the power usage of server farms 172 and cooling systems 180, task success rates which indicate the percentage of tasks 104 completed successfully, latency which indicates delays in processing or transmitting data via the network interfaces 182, and disk I/O rates which indicate the frequency of data read and write operations on storage solutions 184. The sensor data 152 may be used by the automation systems 176 and cooling systems 180 to dynamically adjust data center operations, to increase the performance efficiency and reduce task failures within the data center 130. The sensor circuits 186 may also provide sensor data 152 as feedback to the server farms 172 and power supply system 178 for efficient resource management.

### Example Server

The server 140 generally includes a hardware computer system configured to manage and control data centers 130, according to certain embodiments. In certain embodiments, the server 140 may be implemented by a cluster of computing devices, such as virtual machines. For example, the server 140 may be implemented by a plurality of computing devices using distributed computing and/or cloud computing systems in a network. In certain embodiments, the server 140 may be configured to provide services and resources (e.g., data and/or hardware resources as described herein, etc.) to other components and devices.

The server 140 may comprise a processor 142 operably coupled with a network interface 144 and a memory 146. The processor 142 comprises one or more processors. The processor 142 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the server 140 described herein. In this way, the processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-4. For example, the processor 142 may be configured to perform one or more operations of the operational flow 200 as described in FIG. 2, one or more operations of the method 300 as described in FIG. 3, and one or more operations of the method 400 as described in FIG. 4.

The network interface 144 is configured to enable wired and/or wireless communications. The network interface 144 may be configured to communicate data between the server 140 and other devices, systems, or domains. For example, the network interface 144 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise read-only memory (ROM), random-access memory (RAM), ternary content-addressable memory (TCAM), dynamic random-access memory (DRAM), and/or static random-access memory (SRAM). The memory 146 may include one or more of a local database, a cloud database, a network-attached storage (NAS), etc. The memory 146 comprises one or more disks, tape drives, or solid-state drives, and may be used as an overflow data storage device, to store programs when such programs are selected for execution, and to store instructions and data that are read during program execution. The memory 146 may store any of the information described in FIGS. 1-4 along with any other data, instructions, logic, rules, or code operable to implement the function(s) described herein when executed by processor 142. For example, the memory 146 may store software instructions 148, resources 150, sensor data 152, fixed threshold classification algorithm 154, statistical distribution classification algorithm 156, hybrid classification algorithm 158, distribution index 160, services 161, task metrics 162, threshold values 164a-b, threshold values 166a-b, weight 168, task requirements 230, training dataset 192, operational metrics 188, operational data 214, class tier 210a-c, feedback metrics 242 and 244, classification parameters 226, future task distribution trends 246, configuration criteria 248, network data packet 232, machine learning algorithm 250, and/or any other data or instructions. The software instructions 148 may comprise any suitable set of instructions, logic, rules, or code operable to execute the processor 142 and perform the functions described herein, such as some or all of those described in FIGS. 1-4.

The fixed threshold classification algorithm 154 may be implemented by the processor 142 executing software instructions 148 and is generally configured to determine a class tier 210a-c of a task 104 based on its distribution index 160 using predetermined threshold values 164a-b. The fixed threshold classification algorithm 154 may use predetermined threshold values 164a-b to classify a task 104 into one of multiple class tiers 210a-c. The predetermined threshold values 164a-b may define the boundaries between the class tiers 210a-c where a task 104 may end up being classified. Each class tier 210a-c indicates a level of suitability for offloading a task 104 from the data center 130 to one or more computing devices 120.

In some embodiments, regardless of which classification algorithm is used, the class tiers 210a-c may include a first class tier 210a that indicates that a given task 104 is suitable for offloading from the data center 130, a second class tier 210b that indicates that the task 104 is conditionally suitable for offloading from the data center 130 based on the available computational resources at server farms 172 and/or external computing devices 120, and a third class tier 210c that indicates that the task 104 is not suitable for offloading from the data center 130. In some embodiments, the distribution index 160 may be derived from various task metrics 162, including processing resource utilization, memory usage, network bandwidth usage, and input/output (I/O) throughput. Each of the task metrics 162 may be assigned weight factors to reflect their relative importance in determining the suitability of the task 104 for offloading from the data center 130.

The fixed threshold classification algorithm 154 may utilize predetermined threshold values 164 to classify the task 104 into specific class tiers 210a-c. In the example of fixed threshold classification algorithm 154, a task 104 may be classified into a first class tier 210a if the distribution index 160 exceeds an upper threshold value 164a (e.g., the index 160 is more than 0.8 out of 1.0). If the distribution index 160 of the task 104 is within a range between the upper threshold value 164a and a lower threshold value 164b (e.g., the index 160 is between 0.5 and 0.8), the task 104 may be classified into a second class tier 210b. When the distribution index 160 is less than the lower threshold value 164b (e.g., the index 160 is less than 0.5), the task 104 is classified into a third class tier 210c.

The statistical distribution classification algorithm 156 may be implemented by the processor 142 executing software instructions 148 and is generally configured to determine a class tier 210a-c of a task 104 based on its distribution index 160 using dynamic threshold values 166a-b. The dynamic threshold values 166a-b define the boundaries between the class tiers 210a-c where a task 104 may end up being classified. The statistical distribution classification algorithm 156 may use dynamic threshold values 166a-b to classify a given task 104 into one of multiple class tiers 210a-c based on the distribution index 160 of the task 104. The statistical distribution classification algorithm 156 adapts the classification parameters, such as the threshold values 166 based on the statistical characteristics of historical distribution indices 160 associated with tasks 104 executed within the data center 130 and offloaded tasks 104, such as task success rate, energy utilization, processing resource utilization, memory resource utilization, network resource utilization, thermal dissipation efficiency, among others.

In some embodiments, in the example of statistical distribution classification algorithm 156, each class tier is identified by threshold values 166a-b based on historical distribution indexes 160, such that the task 104 is classified in the first class tier 210a when the distribution index 160 exceeds an upper threshold value 166a, where the upper threshold value 166a is defined by:

$$Upper threshold value = ( Mean score + Stdev \times Multiplier ) \qquad Equation ( 1 )$$

where the Mean score is an average of a set of historical distribution indexes 160 associated with the task 104, the Stdev is a standard deviation of the set of historical distribution indexes 160, and the Multiplier is configured based on historical task success rates in conjunction with executing the task 104.

The task 104 may be classified in the second class tier 210b when the distribution index 160 falls within an intermediate range defined by:

$$Intermedia range = ( Mean score - Stdev \times Multiplier ) <= Distribution score <= ( Mean score + Stdev \times Multiplier ) \qquad Equation ( 2 )$$

The task 104 may be classified in the third class tier 210c when the distribution index 160 is less than a lower threshold value 166b defined by:

$$Lower threshold value = ( Mean score - Stdev \times Multiplier ) \qquad Equation ( 3 )$$

The upper and lower threshold values 166a-b may be dynamically determined by applying a multiplier to the standard deviation and adding or subtracting this product from the mean value of the historical distribution indices 160. In some embodiments, the statistical distribution classification algorithm 156 may be refined by adjusting the multiplier based on historical success rates of offloaded tasks 104. In this manner, the statistical distribution classification algorithm 156 adapts to changes and fluctuations in the operational conditions of the data center 130, such as fluctuating processing loads, memory availability, network congestion, thermal load, etc. In some embodiments, the statistical distribution classification algorithm 156 is particularly useful in scenarios where task execution patterns are not predictable or where static thresholds fail to provide a more optimal task classification and an increase in task failures.

In some embodiments, the statistical distribution classification algorithm 156 may include a support vector machine, neural networks, random forest, k-means clustering, and/or any other classification model, etc. The statistical distribution classification algorithm 156 may be implemented by a plurality of neural network layers, convolutional neural network layers, Long-Short-Term-Memory (LSTM) layers, Bi-directional LSTM layers, recurrent neural network layers, and the like. In some embodiments, the statistical distribution classification algorithm 156 may be implemented by unsupervised, semi-supervised, or supervised machine learning techniques. For example, the statistical distribution classification algorithm 156 may be trained by a training dataset 192 that includes historical task distributions, where each task 104 is labeled with its respective labels (including respective indication of task's class tier, task success or failure outcome, processing, memory, and network resource utilization patterns, energy consumption level, and thermal profile), historical task success and failure rates associated with each of tasks 104 that were performed within the data center 130 and tasks 104 that were offloaded.

The statistical distribution classification algorithm 156 may use the training dataset 192 to predict future fluctuations in task metrics 162 and operational metrics 188, and accordingly, adjust the statistical threshold values 166a-b used to classify tasks 104 into class tiers 210a-c. By analyzing patterns in the training dataset 192 and the current operational patterns, the statistical distribution classification algorithm 156 may dynamically adapt the classification process to proactively accommodate anticipated changes in the conditions of the data center 130. For example, if the training dataset 192 indicates an increase in network congestion during specific periods (e.g., during peak-hours of a day), the statistical distribution classification algorithm 156 may lower the statistical threshold values 166a-b to ensure that tasks 104 are classified in a way that reduces network congestion. Similarly, if the training dataset 192 indicates a rise in thermal load during peak hours, the statistical distribution classification algorithm 156 may adjust the statistical threshold values 166a-b to favor offloading tasks 104 to external computing devices 120 during those times.

The hybrid classification algorithm 158 may be implemented by the processor 142 executing software instructions 148 and is generally configured to determine a class tier of a task 104 based on its distribution index 160 using a weighted combination of fixed threshold values 166a-b and statistical threshold values 166a-b. The weights 168 allocated to the fixed threshold values 166a-b and statistical threshold values 166a-b define the boundaries between the class tiers 210a-c where a task 104 may end up being classified. In the example of the hybrid classification algorithm 158, each class tier 210a-c is identified by a combination of fixed threshold values 166a-b and statistical threshold values 166a-b, such that a class tier 210 associated with the task 104 is determined based on a hybrid tier 210 that is determined by as a weighted combination of fixed threshold values 166a-b and statistical threshold values 166a-b, and defined by:

$$Hybrid tier = α \times ( Fixed threshold tier ) + ( 1 - α ) \times ( Statistical threshold tier ) \qquad Equation ( 4 )$$

where the α is a configurable weighting factor (i.e., weight 168), the Fixed threshold tier is a first classification tier 210 based on a predetermined range of distribution indexes 160 and the Statistical threshold tier is a second classification tier 210 determined based on a set of historical distribution indexes 160 associated with the task 104.

The value of α may be between 0 and 1, where an α value closer to 1 places more emphasis (importance or weight) on the fixed threshold values 16ba-b, and a value closer to 0 places more emphasis on the statistical threshold values 166a-b. Thus, the configurable weights 168 allows the hybrid classification algorithm 158 to adapt to the stability and fluctuations in the data center 130 and upcoming tasks 104. For example, in stable conditions (where the task metrics 162 are not fluctuating more than a threshold range from a baseline and/or the operational metrics 188 of the data center 130 are not fluctuating more than a threshold range from a baseline), the server 140 (e.g., via the hybrid classification algorithm 158) may rely more on fixed threshold values 16ba-b to follow the consistency in the stable conditions. In fluctuating conditions, the server 140 (e.g., via the hybrid classification algorithm 158) may emphasis on statistical threshold values 166a-b to dynamically respond to changing parameters in the operational metrics 188.

In some embodiments, the hybrid classification algorithm 158 may dynamically adjust the weight 168 based on feedback metrics 242. For example, if the server 140 detects fluctuations in processing resource utilization or task failure rates, the server 140 may reduce the a (i.e., weight 168) to rely more on statistical threshold values 166a-b. Otherwise, if the server 140 detects stable conditions, the server 140 may increase the a (i.e., weight 168) to favor fixed threshold values 16ba-b.

The machine learning algorithm 250 may be implemented by the processor 142 executing software instructions 148 and is generally configured to predict further task distribution trends 246 associated with data center 130 and computing devices 120. In some embodiments, the machine learning algorithm 250 may include regression algorithms, and/or any other machine learning model configured to process time-series data, etc. The machine learning algorithm 250 may be implemented by a plurality of neural network layers, convolutional neural network layers, LSTM layers, Bi-directional LSTM layers, recurrent neural network layers, and the like.

In some embodiments, the machine learning algorithm 250 may be implemented by unsupervised, semi-supervised, or supervised machine learning techniques. For example, the machine learning algorithm 250 may implement neural networks to analyze the first feedback metrics 242 and the second feedback metrics 244 to identify patterns and correlations between historical task execution, resource utilization, energy usage, and task success rates in the data center 130 and the external computing devices 120. The machine learning algorithm 250 may be trained to recognize such patterns in the feedback metrics 242 and 244 over time and predict how future tasks 104 are likely to be distributed based on similar conditions within the historical patterns.

In the training process, the machine learning algorithm 250 may generate embedding vectors that represent the patterns and correlations of the content within the feedback metrics 242 and 244 and present the embedding vectors in a vector space. In response, the machine learning algorithm 250 may learn the patterns and correlations and use them to predict how future incoming tasks 104 would be distributed among and between the data center 130 and the external computing devices 120. For example, if feedback metrics 242 and/or 244 indicate that a sudden increase in CPU usage at the server farms 172 under certain operational metric 188 has led to task failures at the server farms 172, the machine learning algorithm 250 may predict a similar outcome if a rise in the CPU usage at the server farms 172 and similar certain operational metric 188 is detected. The server 140 may use the prediction of the machine learning algorithm 250 to proactively adjust the future task distributions to increase the task success rates, resource utilization, and thermal load of the data center 130.

Operational Flow for Determining Candidates for Offloading from a Data Center

FIG. 2 illustrates an example operational flow 200 of the system 100 (see FIG. 1) for determining candidate tasks 104 for offloading from the data center 130 to one or more computing devices 120. In operation, the server 140 may monitor the incoming tasks 104 that the data center 130 is requested to perform, the operations of the data center 130, task success and failure rates, energy usage patterns, thermal load, and other metrics to determine which task(s) 104 are suitable candidates for offloading from the data center 130. For each incoming task 104, the server 140 determines a set of task metrics 162 that indicate whether the task 104 is a suitable candidate for offloading from the data center 130. The task metrics 162 represent the current or actual resource requirements of the task 104 to be executed.

The server 140 may determine the task metrics 162 for each task 104 by analyzing computational parameters 212 associated with the task 104, e.g., by parsing and analyzing a network data packet where the task 104 is contained, historical tasks 104, monitoring data buffers at network interfaces 182, and used/occupied and available memories in storage solutions 184. The computational parameters 212 may be determined by monitoring the software and hardware components of the data center 130. For example, for a given incoming task 104, the server 140 may determine a set of task metrics 162 of the task 104, where the task metrics 162 may indicate whether the task 104 is a suitable candidate for offloading from the data center 130.

In some examples, the task metrics 162 may be determined based on a plurality of computational parameters 212 associated with the task 104. The computational parameters 212 may include an I/O throughput that indicates a data rate required to read data from and write data to the memory (e.g., within the storage solutions 184) to execute the task 104, a disk usage that indicates a capacity of memory disk (e.g., within the storage solutions 184) required to store a set of files associated with the task 104, a memory usage that indicates an amount of cache memory (e.g., within the storage solutions 184) physically required to execute the task 104, a processor utilization that indicates CPU (e.g., within the server farms 172) required to execute the task 104, a network bandwidth that indicates an amount of network resources (e.g., associated with the network interfaces 182) required for data transfer by the task 104, a data locality that indicates a geographic distance between a first memory (e.g., within the storage solutions 184) where the set of files associated with the task 104 is stored and a second memory (e.g., within the storage solutions 184) where computational resources (e.g., within the server farms 172) to execute the task 104 are stored, among others. Some computational parameters 212 may be determined based on electrical signal communications between and among software and/or hardware components within the data center 130. Some computational parameters 212 may include such electrical signal communications.

### Determining a Distribution Index for the Task

The server 140 may use the task metrics 162 to determine a distribution index 160 of the task 104. In this process, in some embodiments, the server 140 may use a weighted sum of certain indexes associated with the task 104. For example, the distribution index 160 may be defined by:

$$Distribution index 160 = W 1 \times I / O index + W 2 \times memory index + W 3 \times CPU index + W 4 \times network index \qquad Equation ( 5 )$$

where each of W1, W2, W3, and W4 indicates a weight factor for a respective index, a sum of W1, W2, W3, and W4 equals to 1.0, the I/O index represents an I/O throughput for the task 104, the memory index represents a storage capacity required to execute the task 104, the CPU index represents a processor utilization associated with executing the task 104, and the network index represents a network bandwidth usage associated with executing the task 104. Each of the weight factors W1, W2, W3, and W4 represents the relative importance of the respective computational parameters 212 for the task 104.

In some embodiments, the weight factors W1, W2, W3, and W4 may be dynamically adjusted by the server 140 based on the operational metrics 188 of the data center 130. For example, if the task 104 requires frequent disk read and write operations (e.g., more than a threshold number of read and write operations per minute), the server 140 may allocate a higher weight factor (e.g., W1=0.4) to the I/O index compared to others. In another example, if the task 104 requires complex computations that require intensive CPU processing (e.g., a CPU utilization with more than 80%, 90%, etc.), the server 140 may allocate a higher weight factor to the CPU index (e.g., W3=0.5) compared to others. In another example, if the task 104 requires extensive data transfers over the network (e.g., a data transfer rate with more than a predefined network bandwidth threshold), the server 140 may assign a higher weight factor to the network index (e.g., W4=0.35) compared to others. In another example, if the task 104 requires high memory storage (e.g., more than a threshold percentage of available RAM, such as more than 20 Gigabyte (Gb), 100 Gb, etc.), the server 140 may increase the weight factor for the memory index (e.g., W2=0.4) compared to others.

In some examples, the operational metrics 188 may be determined by monitoring and analyzing operational data 214 generated by and/or associated with each hardware and/or software components of the data center 130. The server 140 may obtain the operational data 214 through various sensor circuits 186, network interfaces 182, storage solutions 184, and software monitoring tools running on server farms 172. The operational data 214 may include various measurable parameters that indicate the status and performance of the hardware and software components within the data center 130. For example, the operational data 214 may include processing resource utilization which represents the percentage of CPU usage across the server farms 172, that indicate the load on each server, memory usage for executing tasks 104 in storage solutions 184, the data transfer rates and network buffer status of network interfaces 182, which may indicate the network congestion at the data center 130, disk I/O rates at the storage solutions 184, among others.

### Classifying the Task by a Multi-Tier Classification Algorithm

The server 140 classifies the task 104 into one of the class tiers 210a-c by a multi-tier classification algorithm based on the determined distribution index 160. The multi-tier classification algorithm may be any of the fixed threshold classification algorithm 154, the statistical distribution classification algorithm 156, and the hybrid classification algorithm 158. In some embodiments, the server 140 may select and configure each of the classification algorithms based on the training dataset 192, current patterns in energy usage, thermal profile/load, among others. This process is described in greater detail further below.

In the example case where the fixed threshold classification algorithm 154 is selected and configured to classify the task 104, the fixed threshold classification algorithm 154 classifies the task 104 by comparing the distribution index 160 of the task 104 to predefined threshold values 164, similar to that described in FIG. 1. For example, if the distribution index 160 is more than an upper threshold value 164a, the task 104 may be classified into a first class tier 210a, if the distribution index 160 is between the upper threshold value 164a and a lower threshold value 164b, the task 104 may be classified into a second class tier 210b, and if the distribution index 160 is less than the lower threshold value 164b, the task 104 may be classified into a third class tier 210c.

In the example case where the statistical distribution classification algorithm 156 is selected and configured to classify the task 104, the statistical distribution classification algorithm 156 classifies the task 104 by comparing the distribution index 160 of the task 104 to statistical threshold values 166a-b, similar to that described in FIG. 1. In some embodiments, the statistical threshold values 166a-b may be determined based on the mean and standard deviation of historical distribution indexes 160 associated with similar (e.g., corresponding) tasks 104 compared to the task 104 in question, similar to that described in FIG. 1. In some embodiments, the statistical threshold values 166a-b may determine the dynamic threshold values 166a-b based on the training dataset 192. In this process, the statistical distribution classification algorithm 156 may determine the dynamic threshold values 166a-b based on the mean and standard deviation of historical distribution indexes 160 associated with similar (e.g., corresponding) tasks 104 compared to the task 104 in question.

In the example case where the hybrid classification algorithm 158 is selected and configured to classify the task 104, the hybrid classification algorithm 158 may classify the task 104 by comparing the distribution index 160 of the task 104 to the combination of fixed threshold values 164a-b and statistical thresholds 166a-b, and weight 168 (a), similar to that described in FIG. 1. For example, if a is set to 0.7, the hybrid classification algorithm 158 may rely 70% on the fixed threshold values 164 and 30% on the statistical threshold values 166.

In some embodiments, the classification parameters 226 of the fixed threshold classification algorithm 154 (e.g., threshold values 164a-b) may be configured or adjusted based on historical task distributions and their success rates. For example, if historical task distributions indicate that tasks 104 with a distribution index 160 more than a certain value (e.g., more than 0.6) consistently succeed when offloaded, the upper threshold value 164a may be adjusted to allow tasks 104 with distribution indexes 160 more than the certain value to be offloaded and classified in class tier 210a. Similarly, if tasks 104 with distribution indexes 160 less than a certain value (e.g., less than 0.3) frequently fail when offloaded, the lower threshold value 164b may be lowered so that those tasks 104 remain within the data center 130.

In some embodiments, the dynamic threshold values 166a-b and weight 168 may be determined based on the training dataset 192. In the training process, the statistical distribution classification algorithm 156 may receive the training dataset 192, analyze each entry in the training dataset 192 by its neural networks, and learn to identify patterns and correlations between task metrics 162 of a given task 104 and its labels, including respective class tier 210a-c, task success of failure indication, resource utilization patterns, energy consumption, and thermal load requirement. For each task 104 in the training dataset 192, the statistical distribution classification algorithm 156 may extract features such as task success or failure outcome, processing, memory, and network resource utilization patterns, energy consumption level, and thermal profile. In response, the statistical distribution classification algorithm 156 may represent the extracted features by an embedding vector 220 for each task entry from the training dataset 192.

The statistical distribution classification algorithm 156 may represent the embedding vector 220 in a three-dimensional vector space. The statistical distribution classification algorithm 156 may evaluate the historical task distributions and tasks that are performed by the data center 130 based on the associated features and operational metrics 188 of the data center 130. In response, the statistical distribution classification algorithm 156 may determine whether to adjust and/or whether to adjust the classification parameters 226 (e.g., dynamic threshold values 166a-b and weight 168) such that the task success rate increases whether offloaded or performed by the data center 130.

The statistical distribution classification algorithm 156 may identify patterns in the vector space that reflect trends in resource usage, task success rates, and operational conditions of the data center 130. In response, the statistical distribution classification algorithm 156 may use the identified patterns to determine the associated dynamic threshold values 166a-b and weight 168 that adapt to fluctuations in resource availability and operational metrics 188 of the data center 130. The identified patterns may be represented by a historical patterns embedding vector 224 in the vector space.

In the testing process, the dynamic threshold values 166a-b and weight 168 may be applied to an unseen task 104 that is unlabeled. The statistical distribution classification algorithm 156 may extract features from the unseen task 104, generate an embedding vector 222, and represent the generated embedding vector 222 in the three-dimensional vector space. The statistical distribution classification algorithm 156 may compare the embedding vector 222 to the historical patterns embedding vector 224 learned during training to determine the degree of similarity or deviation between them. In this process, the statistical distribution classification algorithm 156 may determine a distance (e.g., Euclidean distance) or cosine similarity between the embedding vector 222 and embedding vector 224. If the distance between the embedding vector 222 and the historical patterns embedding vector 224 is more than a predefined threshold, it may indicate that the operational conditions as indicated by metrics 188 and/or task metrics 162 associated with the unseen task 104 have deviated from previously observed patterns.

In response, the statistical distribution classification algorithm 156 may adjust one or more classification parameters 226 (e.g., dynamic threshold values 166a-b and/or weight 168) to accommodate the detected deviation and counterbalance the detected deviation based on the current conditions, available resources, and available power/energy level. For example, if the unseen task 104 is associated with higher-than-expected CPU utilization or network bandwidth consumption, the statistical distribution classification algorithm 156 may lower the dynamic threshold values 166a-b to offload one or more tasks 104 (e.g., including the unseen task 104) to external computing devices 120 to reduce resource congestion within the data center 130.

In some embodiments, the statistical distribution classification algorithm 156 may compare the embedding vector 220 with the embedding vector 222 to determine to determine the class tier of the unseen task 104, e.g., by determining the similarity or distance between the embedding vector 220 and embedding vector 222. For example, if the distance between the embedding vector 220 and embedding vector 220 is less than a threshold distance, the statistical distribution classification algorithm 156 may classify the unseen task 104 in the same class tier as the training task 104.

### Determining External Computing Devices to Run the Offloaded Task

In response to determining that the task 104 is a candidate for offloading from the data center 130 (e.g, that the task 104 belongs to the first class tie 210a), the server 140 may determine one or more computing devices 120 to run the offloaded task 104. For example, the server 140 may determine that the task 104 is a candidate for offloading from the data center 130 if it is classified in class tier 210a. To this end, the server 140 may determine a set of task requirements 230 for the task 104, where the task requirements 230 may indicate the amount of physical computational resources, physical memory resources, network bandwidth resources required to execute the task 104.

The server 140 may determine the task requirements 230 by analyzing task metrics 162 of the task 104. In response, the server 140 may determine which one or more computing devices 120 can meet the task requirements 230 to execute the task 104. The server 140 may identify any number of computing devices 120 that in the aggregate can meet the task requirements 230 to execute the task 104. If it is determined that a single computing device 120 can meet the task requirements 230, the server 140 may communicate the task 104 to the identified computing device. If it is determined that two or more computing devices 120a-b, in the aggregate, can meet the task requirements 230 to execute the task 104, the server 140 may divide the task 104 into sub-tasks 106a-b, map each sub-task 106a-b to a respective computing device 120a-b that can handle the sub-task 106a-b, and communicate each sub-task 106a-b to the respective computing device 120a-b.

In this process, the server 140 may indicate a network route 236 in a network data packet 232 that contains the information regarding the task 104. The network data packet 232 may include a header 234 that specifies a destination address associated with each computing device 120a-b assigned to handle the sub-tasks 106a-b. The destination address may be an Internet Protocol (IP) address, a Medium Access Control (MAC) address, or other network address formats used for routing data packets to external computing devices 120a-b. In some embodiments, the server 140 may buffer the network data packet 232 in a network buffer prior to its transmission. The server 140 may dynamically construct the network route 236 based on the available network paths and current network conditions, such as bandwidth availability, latency, and packet loss rates. The server 140 may insert routing information in specific bit-fields within the header 234 of the network data packet 232. For example, the routing information may include details about the network traverse of the data packet 232, such as intermediate network nodes, ports numbers of the network nodes, network hops, and the like.

In some embodiments, the server 140 may be configured to divide a task 104 into two or more sub-tasks 106a-b according to the processing capabilities of each external computing device 120a-b, distribute each sub-tasks 106a-b to the respective/mapped external computing devices 120a-b, monitor the task execution at each computing device 120a-b, and receive and aggregate the results 129 of the executions. The server 140 may map each sub-task 106a-b to a respective external computing device 120a-b that meets the processing requirements of the sub-task 106a-b according to the processing capability of each of the external computing devices 120a-b. when the sub-tasks 106a-b are mapped, the server 140 may communicate each sub-task 106a-b to the corresponding external computing device 120a-b, e.g., based on the routing information regarding each sub-task and indicating a network route 236 in the packet 232.

After the external computing devices 120a-b execute their respective sub-tasks 106a-b, they may generate partial results 129a-b and communicate the partial results 129a-b, respectively, back to the server 140. The server 140 may receive the partial results 129a-b and determine the order in which they need to be assembled based on any dependencies between the sub-tasks 106a-b. For example, if sub-task 106a generates data required by sub-task 106b, the server 140 determines that the result 129a of sub-task 106a is processed before sub-task 106b. The server 140 may assemble the partial results 129a-b according to the determined order and dependencies between the sub-tasks 106a-b.

### Detecting and Mitigating Failed Tasks

In some embodiments, the server 140 may detect and mitigate failed tasks 104. The server 140 may monitor the execution of each task 104 and corresponding sub-tasks 106a-b at the external computing devices 120a-b. For example, the server 140 may monitor task execution time, resource utilization, error rates, and network status. If the server 140 detects a failure in the execution of a sub-task 106a at one of the external computing devices 120a, the server 140 may analyze the root cause of the failure based on factors such as insufficient processing capability, lack of available storage, a congested network buffer, etc., at the external computing device 120a. In response to identifying the root cause, the server 140 may dynamically identify a counterpart external computing device 120b that has at least the required resources and capability to execute the sub-task 106a. In response, the server 140 may reassign the sub-task 106a to the identified counterpart external computing device 120b and transmit the sub-task 106a to the counterpart external computing device 120b.

If the counterpart external computing device 120b also fails to execute the sub-task 106a, the server 140 may retrieve the sub-task 106a back to the data center 130. The server 140 and/or server farms 170 may allocate the required resources within the data center 130 to execute the sub-task 106a.

In some embodiments, the server 140 may log the occurrences of task failures and the subsequent mitigation actions performed. For example, the server 140 may log information about the failed external computing devices 120, root causes of the failures, and the success rates of mitigation actions. The server 140 may use the logged data as feedback to improve future task distribution and offloading decisions.

### Revising Classification Parameters Based on Predicted Data

In some embodiments, the server 140 may revise the classification parameters 226 based on predicted data including future energy usage, future resource (e.g., processing, memory, and network) availability, among other factors associated with the data center 130. To this end, in some embodiments, the server 140 may execute at least one of classification algorithms (e.g., fixed threshold classification algorithm 154, statistical distribution classification algorithms 156, and/or hybrid classification algorithm 158) to determine whether a given task 104 is a candidate for offloading from the data center 130.

The server 140 may distribute one or more first tasks 104 to a set of internal computing devices (e.g., server farms 172) within the data center 130 to be executed. In response, the server farms 172 may execute the tasks 104. The server 140 may determine a first feedback metric 242 associated with the server farms 172 based on analyzing the operational metrics 188, operational data 214, and sensor data 152. The first feedback metric 242 may comprises an energy usage pattern, a thermal profile, CPU utilization, memory consumption, network bandwidth usage, energy consumption, and a task success rate associated with the first tasks 104 executed by the server farms 172. The first feedback metric 242 may be associated with any or any combination of components of the data center 130.

The server 140 may distribute one or more second tasks 104 to a set of external computing devices 120a-b to be executed. In response, the server 140 may determine a second feedback metric 244 associated with the set of external computing devices 120 based on monitoring the processing, memory, and network resource usage, among others at the computing devices 120. The second feedback metric 244 may include an energy usage pattern, a network latency, CPU utilization, memory consumption, network bandwidth usage, energy consumption, a task success rate associated with the second tasks 104 offloaded to the set of external computing devices 120a-b. The second feedback metric 244 may indicate parameters such as processing resource availability, network latency, memory usage, and energy consumption.

The server 140 may use the first feedback metrics 242 and the second feedback metrics 244 to determine a future task distribution trend 246 from the data center 130 to the set of external computing devices 120. The future task distribution trend 246 may indicate predicted patterns in task allocation based on current and historical feedback metrics 242 and 244, resource availability, and operational conditions determined based on operational data 214, operational metrics 188, and sensor data 152. In this process, the server 140 may use the first feedback metrics 242 and the second feedback metrics 244 as training datasets for the machine learning algorithm 250 to predict the future task distribution trend 246, similar to that described in FIG. 1.

The server 140 may determine whether there is a fluctuation in the future task distribution trend 246, e.g., based on the output of the machine learning algorithm 250. For example, a fluctuation in the future task distribution trend 246 may be a change in resource availability, network bandwidth, processing loads, energy consumption, or thermal conditions, where the change is more than a threshold range from a respective baseline. If it is determined that there is no fluctuation in the future task distribution trend 246, the server 140 may continue executing the current classification algorithm and maintain the existing classification parameters 226 without modifying them. Otherwise, if a fluctuation in the future task distribution trend 246 is detected, the server 140 may respond by dynamically adjusting the classification parameters 226 and the configuration criteria 248 for selecting the classification algorithm. For example, the server 140 may, for the statistical distribution classification algorithm 156, adjust at least one of the set of classification parameters 226 based on the first feedback metrics 242 and the second feedback metrics 244 to account for the detected fluctuation in resource availability or operational conditions of the data center 130. For example, the adjustment to the classification parameters 226 may cause an adjustment in classification of an upcoming task 104 by the statistical distribution classification algorithm 156 according to the detected fluctuation in the future task distribution trend 246. In some examples, the adjusted classification parameter 226 may include the dynamic threshold value 166a-b for each class tier 210a-c associated with the statistical distribution classification algorithm 156, a multiplier factor that indicates a priority level of a task metric 162 as described in Equations 2 and 3 in FIG. 1, where the task metric 162 may include a processing resource utilization, a network bandwidth, a memory usage, and an alpha (α) parameter (i.e., weight 168) that is used to balance between fixed threshold values 164a-b and statistical threshold values 166a-b.

In some embodiments, the server 140 (e.g., based on the output of the machine learning algorithm 250) may adjust the configuration criteria 248 to select a classification algorithm that accommodates the detected fluctuation in the future task distribution trend 246. For example, if the feedback metrics 242 and 244 indicate highly variable resource utilization or network congestion, the server 140 may select the statistical distribution classification algorithm 156 or the hybrid classification algorithm 158 to provide adaptive task classification and distribution. The adjustment to the configuration criteria 248 allows that a classification algorithm that accommodates the detected fluctuation in the future task distribution trend 246 is implemented by the server 140. The server 140 may perform similar operations for each of other classification algorithms, e.g., fixed threshold classification algorithms 154 and hybrid classification algorithm 158.

In some embodiments, the server 140 may adjust at least one of the classification parameters 226 based on predicted conditions (e.g., indicated by operational metrics 188 and operational data 214) within the data center 130. In some embodiments, the server 140 may adjust or revise classification parameters 226 and/or configuration criteria 248 in response to detecting a fluctuation in predicted conditions at the data center 130, including predicted resource availability, energy level availability, among others, detecting a fluctuation in predicted conditions at the data center 130 may include increase or decrease more than a respective threshold value from an expected range for any of the operational metrics 188.

In some embodiments, adjusting the set of classification parameters 226 may be in response to determining that a predicted processing resource utilization associated with the set of internal computing devices (e.g., server farms 172) will be less than a predefined threshold (e.g., less than 60%), determining that a predicted thermal profile associated with the set of internal computing devices (e.g., server farms 172) will be more than a pre-configured thermal limit (e.g., more than 85° C.), determining that a predicted network bandwidth usage associated with the set of internal computing devices (e.g., server farms 172) will be more than an allocated bandwidth usage (e.g., more than 90% of the allocated 1 Gigabit per second (Gbps)), and/or determining that a predicted task success rate associated with the set of internal computing devices (e.g., server farms 172) will be less than a predefined threshold rate (e.g., less than 80%).

For example, if the predicted processing resource utilization of the internal computing devices (e.g., server farms 172) is less than a predefined threshold (e.g., less than 60%), the server 140 may adjust the classification parameters 226 to retain more tasks 104 in the data center 130. If the predicted thermal profile of the data center 130 is more than a pre-configured thermal limit (e.g., above 85° C.), the server 140 may adjust the classification parameters 226 to offload tasks 104 to external computing devices 120 to reduce thermal load. If the predicted network bandwidth usage is expected to be become more than an allocated bandwidth (e.g., more than 90% of allocated 1 Gbps), the server 140 may offload network-intensive tasks 104 to reduce network congestion. If the predicted task success rate is less than a predefined threshold (e.g., less than 80%), the server 140 may offload tasks 104 to increase the task success rate at the data center 130.

In some embodiments, the server 140 may adjust the configuration criteria 248 for selecting which classification algorithm to implement for an upcoming task 104 based on predicted conditions within the data center 130. In some embodiments, adjusting the configuration criteria may be in response to determining that a predicted processing resource utilization associated with the set of internal computing devices (e.g., server farms 172) will be less than a predefined threshold (e.g., less than 60%), determining that a predicted thermal profile associated with the set of internal computing devices (e.g., server farms 172) will be more than a pre-configured thermal limit (e.g., more than 85° C.), determining that a predicted network bandwidth usage associated with the set of internal computing devices (e.g., server farms 172) will be more than an allocated bandwidth usage (e.g., more than 90% of the allocated 1 Gbps), and/or determining that a predicted task success rate associated with the set of internal computing devices (e.g., server farms 172) will be less than a predefined threshold rate (e.g., less than 80%).

For example, if the predicted processing resource utilization of the internal computing devices (e.g., server farms 172) is less than a predefined threshold (e.g., less than 60%), the server 140 may select a classification algorithm with classification parameters 226 that favors retaining tasks 104 within the data center 130. If the predicted thermal profile of the internal computing devices (e.g., server farms 172) is more than a pre-configured thermal limit (e.g., more than 85° C.), the server 140 may select a classification algorithm with classification parameters 226 that favors offloading tasks 104 to external computing devices 120 to reduce thermal load. If the predicted network bandwidth usage is expected to exceed the allocated bandwidth (e.g., more than 90% of the allocated 1 Gbps), the server 140 may select a classification algorithm with classification parameters 226 that prioritizes offloading network-intensive tasks 104 to reduce network congestion. If the predicted task success rate is less than a predefined threshold (e.g., less than 80%), the server 140 may choose a classification algorithm with classification parameters 226 that favors offloading tasks 104 to increase the task success rate at the data center 130.

In some embodiments, the server 140 may determine a future energy usage pattern for upcoming task executions based on the first feedback metric 242 and the second feedback metric 244. The server 140 may detect fluctuations in the future energy usage pattern, such as predicted increases or decreases beyond predefined threshold values. In response to detecting a fluctuation in the future energy usage pattern, the server 140 may adjust the classification parameters 226 based on the detected fluctuation in the future energy usage pattern. For example, if a predicted increase in energy usage is detected, the server 140 may offload more tasks 104 to external computing devices 120 to reduce the energy load on the data center 130. In another example, if a decrease in future energy usage is predicted, more tasks 104 may be retained within the data center 130.

In some embodiments, the server 140 may detect a fluctuation in the future task distribution trend 246 based on predicted conditions for both the internal computing devices (e.g., server farms 172) and external computing devices 120. In some examples, the fluctuation in the future task distribution trend 246 may include a predicted increase in computational processing demand for the internal computing devices (e.g., server farms 172), a predicted decrease in network bandwidth availability for the internal computing devices (e.g., server farms 172), a predicted increase in cooling requirements for the internal computing devices (e.g., server farms 172), a predicted increase in energy consumption for the internal computing devices (e.g., server farms 172), among others. In some examples, the fluctuation may include a predicted increase in computational processing demand for the external computing devices 120, a predicted decrease in network bandwidth availability for the external computing devices 120, a predicted increase in energy consumption for the external computing devices 120, among others. In response to detecting any of such fluctuations, the server 140 may dynamically adjust the classification parameters 226 and/or the configuration criteria 248 to improve task distribution, increase the task success rates, reduced overhead from any internal or external computing device, and balance the workload across the server farm 172 of the data center 130 and the external computing devices 120.

### Example Method for Determining Candidates for Task Offloading Using a Multi-Tier Classification in Data Centers

FIG. 3 illustrates an example flowchart of a method 300 for determining candidates for task offloading using a multi-tier classification in data centers, according to some embodiments. Modifications, additions, or omissions may be made to method 300. Method 300 may include more, fewer, or other operations. For example, operations may be performed in parallel or in any suitable order. While at times it is discussed that the system 100, computing devices 120a-b, data center 130, server 140, or components of any of thereof perform some operations, any suitable system or components of the system may perform one or more operations of the method 300. For example, one or more operations of method 300 may be implemented, at least in part, in the form of software instructions 148 of FIG. 1, stored on a tangible, non-transitory, machine-readable medium (e.g., memory 146 of FIG. 1) that when run by one or more processors (e.g., processor 142 of FIG. 1) may cause the one or more processors to perform operations 302-328.

At operation 302, the server 140 may access a plurality of tasks 104 associated with a data center 130, similar to that described in FIGS. 1-2.

At operation 304, the server 140 may select a task 104 from among the plurality of tasks 104, similar to that described in FIGS. 1-2.

The server 140 may iteratively select a task 104 from the plurality of tasks 104 until no task is left for evaluation, similar to that described in FIGS. 1-2.

At operation 306, the server 140 may determine a set of task metrics 162 associated with the task 104, similar to that described in FIGS. 1-2.

At operation 308, the server 140 determines a distribution index 160 for the task 104 based on the set of task metrics 162, similar to that described in FIGS. 1-2.

At operation 310, the server 140 configures a classification algorithm to classify the task 104 into one of a plurality of class tiers 210a-c based on the distribution index 160, similar to that described in FIGS. 1-2. For example, the server 140 may determine which of the classification algorithms, including fixed threshold classification algorithm 154, statistical distribution classification algorithm 156, and hybrid classification algorithm 158 to implement to classify the task 104.

At operation 312, the server 140 determines whether the task 104 is a candidate for offloading from the data center 130. The server 140 may determine that the task 104 is a candidate for offloading from the data center 130 if the task 104 is classified in the first class tier 210a, similar to that described in FIGS. 1-2. If it is determined that the task 104 is a candidate for offloading from the data center 130, the method 300 proceeds to operation 314. Otherwise, the method 300 proceeds to operation 324.

At operation 314, the server 140 determines a set of task requirements 230 associated with the task 104, similar to that described in FIGS. 1-2.

At operation 316, the server 140 identifies one or more external computing devices 120a-b that met the set of task requirements 230.

At operation 318, the server 140 indicates a network route 236 in a network data packet 232 that contains the information regarding the task 104, similar to that described in FIGS. 1-2. At operation 320, the server 140 transmits the network data packet 232 to the determined external computing device(s) 120a-b, similar to that described in FIGS. 1-2.

At operation 322, the server 140 determines whether to select another task 104. The server 140 may determine to select another task 104 if at least one task 104 is left for evaluation. If it is determined that at least one task 104 is left for evaluation, the method 300 returns to operation 304. Otherwise, the method 300 ends.

At operation 324, the server 140 determines whether the task 104 is a conditional candidate for offloading from the data center 130, similar to that described in FIGS. 1-2. For example, the server 140 may determine that the task 104 is a conditional candidate for offloading from the data center 130, if the task 104 is classified in the second class tier 210b. If it is determined that the task 104 is a conditional candidate for offloading, the method 300 proceeds to operation 368. Otherwise, the method 300 proceeds to operation 328.

At operation 326, the server 140 assigns the task 104 to be executed within the data center 130, similar to that described in FIGS. 1-2.

At operation 328, the server 140 maintains the task 104 in a queue of tasks 104 to be evaluated for offloading based on resource availability and system conditions at the data center 130. The server 140 may proceed to operation 322 in response to the task 104 being maintained in the queue of tasks 104 to be evaluated for offloading.

### Example Method for Revising Classification Parameters Based on Predicted Data

FIG. 4 illustrates an example flowchart of a method 400 for revising classification parameters 226 based on predicted data, according to some embodiments. Modifications, additions, or omissions may be made to method 400. Method 400 may include more, fewer, or other operations. For example, operations may be performed in parallel or in any suitable order. While at times it is discussed that the system 100, computing devices 120a-b, data center 130, server 140, or components of any of thereof perform some operations, any suitable system or components of the system may perform one or more operations of the method 300. For example, one or more operations of method 300 may be implemented, at least in part, in the form of software instructions 148 of FIG. 1, stored on a tangible non-transitory machine-readable medium (e.g., memory 146 of FIG. 1) that when run by one or more processors (e.g., processor 142 of FIG. 1) may cause the one or more processors to perform operations 402-416.

At operation 402, the server 140 executes one of the plurality of classification algorithms to determine whether a given task 104 is a candidate for offloading from a data center 130, similar to that described in FIGS. 1-2.

At operation 404, the server 140 distributes one or more first tasks 104 to a set of internal computing devices (e.g., server farms 172) within the data center 130 for execution, similar to that described in FIGS. 1-2.

At operation 406, the server 140 determines a first feedback metric 242 associated with the set of internal computing devices, similar to that described in FIGS. 1-2.

At operation 408, the server 140 distributes one or more second tasks 104 to a set of external computing devices 120a-b with respect to the data center 130, similar to that described in FIGS. 1-2.

At operation 410, the server 140 determines a second feedback metric 244 associated with the set of external computing devices 120a-b, similar to that described in FIGS. 1-2.

At operation 412, the server 140 determines a future task distribution trend 246 from the data center 130 to the set of external computing devices 120a-b based on the first feedback metric 242 and the second feedback metric 244, similar to that described in FIGS. 1-2.

At operation 414, the server 140 determines whether a fluctuation is detected in the future task distribution trend 246, similar to that described in FIGS. 1-2. If it is determined that the future task distribution trend 246 shows a fluctuation, the method 400 proceeds to operation 414. Otherwise, the method 400 returns to operation 402.

At operation 414, the server 140 adjusts at least one classification parameter 226 based on the first feedback metric 242 and the second feedback metric 244, similar to that described in FIGS. 1-2.

At operation 416, the server 140 adjusts a configuration criteria 248 for which classification algorithm to be implemented for an upcoming task 104 based on the first feedback metric 242 and the second feedback metric 244.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112 (f), as it exists on the date of filing hereof, unless the words “means for” or “step for” are explicitly used in the particular claim.

1. A system comprising:
a memory configured to store a plurality of classification algorithms, wherein:
each of the plurality of classification algorithms is pre-configured with a set of classification parameters; and
a processor, operably coupled to the memory, and configured to:
execute one of the plurality of classification algorithms to determine whether a given task is a candidate for offloading from a data center;
distribute one or more first tasks to a set of internal computing devices within the data center for execution;
in response to distributing the one or more first tasks to the set of internal computing devices within the data center, determine a first feedback metric associated with the set of internal computing devices within the data center, wherein the first feedback metric indicates a resource utilization pattern of the set of internal computing devices executing the one or more first tasks;
distribute one or more second tasks to a set of external computing devices, wherein the set of external computing devices are external with respect to the data center;
in response to distributing the one or more second tasks to the set of external computing devices, determine a second feedback metric associated with the set of external computing devices, wherein the second feedback metric indicates a resource utilization pattern of the set of external computing devices executing the one or more second tasks;
determine a future task distribution trend from the data center to the set of external computing devices based, at least in part, upon the first feedback metric and the second feedback metric;
detect a fluctuation in the future task distribution trend;
in response to detecting the fluctuation in the future task distribution trend:
for a first classification algorithm from among the plurality of classification algorithms, adjust at least one of the set of classification parameters, based, at least in part, upon the first feedback metric and the second feedback metric, wherein the adjustment to the at least one of the set of classification parameters causes an adjustment in classification of an upcoming task by the first classification algorithm according to the detected fluctuation in the future task distribution trend; and
adjust a configuration criteria for which classification algorithm to be implemented for the upcoming task based, at least in part, upon the first feedback metric and the second feedback metric, wherein the adjustment to the configuration criteria allows that a classification algorithm that accommodates the detected fluctuation in the future task distribution trend is implemented.

2. The system of claim 1, wherein adjusting the at least one of the set of classification parameters is in response to at least one of the following:
determining that a predicted processing resource utilization associated with the set of internal computing devices will be less than a predefined threshold;
determining that a predicted thermal profile associated with the set of internal computing devices will be more than a pre-configured thermal limit;
determining that a predicted network bandwidth usage associated with the set of internal computing devices will be more than an allocated bandwidth usage; or
determining that a predicted task success rate associated with the set of internal computing devices will be less than a predefined threshold rate.

3. The system of claim 1, wherein adjusting the configuration criteria for which classification algorithm to be implemented for the upcoming task is in response to at least one of the following:
determining that a predicted processing resource utilization associated with the set of internal computing devices will be less than a predefined threshold;
determining that a predicted thermal profile associated with the set of internal computing devices will be more than a pre-configured thermal limit;
determining that a predicted network bandwidth usage associated with the set of internal computing devices will be more than an allocated bandwidth usage; or
determining that a predicted task success rate associated with the set of internal computing devices will be less than a predefined threshold rate.

4. The system of claim 1, wherein the first feedback metric comprises at least one of an energy usage pattern, a thermal profile, or a task success rate associated with the one or more first tasks executed by the set of internal computing devices.

5. The system of claim 1, wherein the second feedback metric comprises at least one of an energy usage pattern, a network latency, or a task success rate associated with the one or more second tasks offloaded to the set of external computing devices.

6. The system of claim 1, wherein the at least one adjusted classification parameter comprises:
a threshold value for each class tier associated with the first classification algorithm;
a multiplier factor that indicates a priority level of a task metric, comprising a processing resource utilization, a network bandwidth, or a memory usage; or
an alpha parameter that is used to balance between fixed thresholds and statistical thresholds, wherein the fixed thresholds are used to define boundaries between class tiers of a fixed classification algorithm, wherein the statistical thresholds are used to define boundaries between class tiers of a statistical classification algorithm.

7. The system of claim 1, wherein:
the processor is further configured to:
determine a future energy usage pattern for upcoming task executions based, at least in part, upon the first feedback metric and the second feedback metric; and
detect a fluctuation in the future energy usage pattern; and
the adjustment to the at least one of the set of classification parameters is further based, at least in part, upon the detected fluctuation in the future energy usage pattern.

8. A method comprising:
executing one of a plurality of classification algorithms to determine whether a given task is a candidate for offloading from a data center, wherein each of the plurality of classification algorithms is pre-configured with a set of classification parameters;
distributing one or more first tasks to a set of internal computing devices within the data center for execution;
in response to distributing the one or more first tasks to the set of internal computing devices within the data center, determining a first feedback metric associated with the set of internal computing devices within the data center, wherein the first feedback metric indicates a resource utilization pattern of the set of internal computing devices executing the one or more first tasks;
distributing one or more second tasks to a set of external computing devices, wherein the set of external computing devices are external with respect to the data center;
in response to distributing the one or more second tasks to the set of external computing devices, determining a second feedback metric associated with the set of external computing devices, wherein the second feedback metric indicates a resource utilization pattern of the set of external computing devices executing the one or more second tasks;
determining a future task distribution trend from the data center to the set of external computing devices based, at least in part, upon the first feedback metric and the second feedback metric;
detecting a fluctuation in the future task distribution trend;
in response to detecting the fluctuation in the future task distribution trend:
for a first classification algorithm from among the plurality of classification algorithms, adjusting at least one of the set of classification parameters based, at least in part, upon the first feedback metric and the second feedback metric, wherein the adjustment to the at least one of the set of classification parameters causes an adjustment in classification of an upcoming task by the first classification algorithm according to the detected fluctuation in the future task distribution trend; and
adjusting a configuration criteria for which classification algorithm to be implemented for the upcoming task based, at least in part, upon the first feedback metric and the second feedback metric, wherein the adjustment to the configuration criteria allows that a classification algorithm that accommodates the detected fluctuation in the future task distribution trend is implemented.

9. The method of claim 8, wherein adjusting the at least one of the set of classification parameters is in response to at least one of the following:
determining that a predicted processing resource utilization associated with the set of internal computing devices will be less than a predefined threshold;
determining that a predicted thermal profile associated with the set of internal computing devices will be more than a pre-configured thermal limit;
determining that a predicted network bandwidth usage associated with the set of internal computing devices will be more than an allocated bandwidth usage; or
determining that a predicted task success rate associated with the set of internal computing devices will be less than a predefined threshold rate.

10. The method of claim 8, wherein adjusting the configuration criteria for which classification algorithm to be implemented for the upcoming task is in response to at least one of the following:
determining that a predicted processing resource utilization associated with the set of internal computing devices will be less than a predefined threshold;
determining that a predicted thermal profile associated with the set of internal computing devices will be more than a pre-configured thermal limit;
determining that a predicted network bandwidth usage associated with the set of internal computing devices will be more than an allocated bandwidth usage; or
determining that a predicted task success rate associated with the set of internal computing devices will be less than a predefined threshold rate.

11. The method of claim 8, wherein the first feedback metric comprises at least one of an energy usage pattern, a thermal profile, or a task success rate associated with the one or more first tasks executed by the set of internal computing devices.

12. The method of claim 8, wherein the second feedback metric comprises at least one of an energy usage pattern, a network latency, or a task success rate associated with the one or more second tasks offloaded to the set of external computing devices.

13. The method of claim 8, wherein the at least one adjusted classification parameter comprises:
a threshold value for each class tier associated with the first classification algorithm;
a multiplier factor that indicates a priority level of a task metric, comprising a processing resource utilization, a network bandwidth, or a memory usage; or
an alpha parameter that is used to balance between fixed thresholds and statistical thresholds, wherein the fixed thresholds are used to define boundaries between class tiers of a fixed classification algorithm, wherein the statistical thresholds are used to define boundaries between class tiers of a statistical classification algorithm.

14. The method of claim 8, wherein:
the method further comprises:
determining a future energy usage pattern for upcoming task executions based, at least part, upon the first feedback metric and the second feedback metric; and
detecting a fluctuation in the future energy usage pattern; and
the adjustment to the at least one of the set of classification parameters is further based, at least in part, upon the detected fluctuation in the future energy usage pattern.

15. A non-transitory computer-readable medium storing instructions that, when executed by a processor, cause the processor to:
execute one of a plurality of classification algorithms to determine whether a given task is a candidate for offloading from a data center, wherein each of the plurality of classification algorithms is pre-configured with a set of classification parameters;
distribute one or more first tasks to a set of internal computing devices within the data center for execution;
in response to distributing the one or more first tasks to the set of internal computing devices within the data center, determine a first feedback metric associated with the set of internal computing devices within the data center, wherein the first feedback metric indicates a resource utilization pattern of the set of internal computing devices executing the one or more first tasks;
distribute one or more second tasks to a set of external computing devices, wherein the set of external computing devices are external with respect to the data center;
in response to distributing the one or more second tasks to the set of external computing devices, determine a second feedback metric associated with the set of external computing devices, wherein the second feedback metric indicates a resource utilization pattern of the set of external computing devices executing the one or more second tasks;
determine a future task distribution trend from the data center to the set of external computing devices based, at least in part, upon the first feedback metric and the second feedback metric;
detect a fluctuation in the future task distribution trend;
in response to detecting the fluctuation in the future task distribution trend:
for a first classification algorithm from among the plurality of classification algorithms, adjust at least one of the set of classification parameters based, at least in part, upon the first feedback metric and the second feedback metric, wherein the adjustment to the at least one of the set of classification parameters causes an adjustment in classification of an upcoming task by the first classification algorithm according to the detected fluctuation in the future task distribution trend; and
adjust a configuration criteria for which classification algorithm to be implemented for the upcoming task based, at least in part, upon the first feedback metric and the second feedback metric, wherein the adjustment to the configuration criteria allows that a classification algorithm that accommodates the detected fluctuation in the future task distribution trend is implemented.

16. The non-transitory computer-readable medium of claim 15, wherein adjusting the at least one of the set of classification parameters is in response to at least one of the following:
determining that a predicted processing resource utilization associated with the set of internal computing devices will be less than a predefined threshold;
determining that a predicted thermal profile associated with the set of internal computing devices will be more than a pre-configured thermal limit;
determining that a predicted network bandwidth usage associated with the set of internal computing devices will be more than an allocated bandwidth usage; or
determining that a predicted task success rate associated with the set of internal computing devices will be less than a predefined threshold rate.

17. The non-transitory computer-readable medium of claim 15, wherein adjusting the configuration criteria for which classification algorithm to be implemented for the upcoming task is in response to at least one of the following:
determining that a predicted processing resource utilization associated with the set of internal computing devices will be less than a predefined threshold;
determining that a predicted thermal profile associated with the set of internal computing devices will be more than a pre-configured thermal limit;
determining that a predicted network bandwidth usage associated with the set of internal computing devices will be more than an allocated bandwidth usage; or
determining that a predicted task success rate associated with the set of internal computing devices will be less than a predefined threshold rate.

18. The non-transitory computer-readable medium of claim 15, wherein the first feedback metric comprises at least one of an energy usage pattern, a thermal profile, or a task success rate associated with the one or more first tasks executed by the set of internal computing devices.

19. The non-transitory computer-readable medium of claim 15, wherein the at least one adjusted classification parameter comprises:
a threshold value for each class tier associated with the first classification algorithm;
a multiplier factor that indicates a priority level of a task metric, comprising a processing resource utilization, a network bandwidth, or a memory usage; or
an alpha parameter that is used to balance between fixed thresholds and statistical thresholds, wherein the fixed thresholds are used to define boundaries between class tiers of a fixed classification algorithm, wherein the statistical thresholds are used to define boundaries between class tiers of a statistical classification algorithm.

20. The non-transitory computer-readable medium of claim 15, wherein the fluctuation in the future task distribution trend comprises at least one of the following:
a predicted increase in a computational processing demand by the set of internal computing devices;
a predicted decrease in network bandwidth availability for the set of internal computing devices;
a predicted increase in a cooling requirement for the set of internal computing devices;
a predicted increase in an energy consumption for the set of internal computing devices;
a predicted increase in a computational processing demand by the set of external computing devices;
a predicted decrease in network bandwidth availability for the set of external computing devices; or
a predicted increase in an energy consumption for the set of external computing devices.
